(19) United States
(12) Patent Application Publication
(10) Pub. No.: US 2022/0077477 A1
(43) Pub. Date: Mar. 10, 2022

(54) Unit Cell for Fuel Cell and Fuel Cell Stack Including Same

(71) Applicants: Hyundai Motor Company, Seoul (KR); Kia Motors Corporation, Seoul (KR)

(72) Inventors: Woo Chul Shin, Goyang-si (KR); Kyung Min Kim, Namyangju-si (KR)

(21) Appl. No.: 17/145,567

(22) Filed: Jan. 11, 2021

(30) Foreign Application Priority Data
Sep. 4, 2020 (KR) 10-2020-0113120

(51) Int. Cl. H01M 8/0247; H01M 8/0267; H01M 8/0258; H01M 8/1004; H01M 8/241; H01M 8/2483; H01M 8/04007; H01M 8/04701; H01M 4/88

(52) U.S. Cl. CPC H01M 8/0247; H01M 8/0267; H01M 8/0258; H01M 8/1004; H01M 4/8807; H01M 8/2483; H01M 8/04007; H01M 8/04731; H01M 8/241

(57) ABSTRACT

A unit cell for a fuel cell includes a membrane electrode body, a pair of gas diffusion layers disposed on both sides of the membrane electrode body, and a pair of separators disposed outside the gas diffusion layers, and including a gas path formed on a surface facing each of the gas diffusion layers and configured to allow reaction gas to flow therethrough, and a coolant path formed on a surface opposite to the surface facing each of the gas diffusion layers and configured to allow coolant to flow therethrough, wherein an inverse forming portion is formed on at least one of both sides of an outermost region in a transverse direction of each of the separators to be bent towards the surface opposite to the surface facing each of the gas diffusion layers.

### CROSS-REFERENCE TO RELATED APPLICATIONS

This application claims priority to Korean Patent Application No. 10-2020-0113120, filed on Sep. 4, 2020, which application is hereby incorporated herein by reference.

### TECHNICAL FIELD

The present invention relates to a unit cell for a fuel cell and a fuel cell stack including the unit cell.

### BACKGROUND

A fuel cell is a kind of power generator that converts chemical energy of fuel into electric energy by electrochemically reacting the fuel in a stack. The fuel cell may not only supply driving power for industries, homes, and vehicles, but also be used to supply power for a small electronic product such as a portable device. Recently, the use of the fuel cell as a high-efficient clean energy source is gradually expanding.

A unit cell of a general fuel cell has a membrane electrode assembly (MEA) in an innermost portion. The MEA includes a polymer electrolyte membrane that may migrate proton and catalyst layers, i.e. an anode electrode layer and a cathode electrode layer that are coated on both sides of the electrolyte membrane to allow hydrogen and oxygen to react with each other.

Furthermore, a pair of gas diffusion layers (GDL) is stacked on outermost portions of the MEA, i.e. outer portions in which the anode electrode layer and the cathode electrode layer are located. A separator is located outside each gas diffusion layer to form a path where reaction gas, such as hydrogen or air, and coolant are supplied, and water generated by the reaction is discharged.

The foregoing is intended merely to aid in the understanding of the background of the present invention, and is not intended to mean that the present invention falls within the purview of the related art that is already known to those skilled in the art.

### SUMMARY

The present invention relates to a unit cell for a fuel cell and a fuel cell stack including the unit cell. Particular embodiments relate to a unit cell for a fuel cell and a fuel cell stack including the unit cell, which can secure structural stability while preventing an excessive amount of coolant from flowing in an outermost path formed in a separator.

Accordingly, embodiments of the present invention have been made keeping in mind problems occurring in the related art, and an embodiment of the present invention provides a unit cell for a fuel cell, capable of preventing an excessive amount of coolant from flowing in an outermost path formed in a separator.

An embodiment of the present invention provides a unit cell for a fuel cell, including a membrane electrode body, a pair of gas diffusion layers disposed on both sides of the membrane electrode body, and a pair of separators disposed outside the gas diffusion layers, and including a gas path formed on a surface facing each of the gas diffusion layers to allow reaction gas to flow therethrough, and a coolant path formed on a surface opposite to the surface facing each of the gas diffusion layers to allow coolant to flow therethrough, wherein an inverse forming portion may be formed on at least one of both sides of an outermost region in a transverse direction of each of the separators to be bent towards the surface opposite to the surface facing each of the gas diffusion layers.

The separator may include a flat portion formed on each of the separators to extend in an outward direction of the separator while being bent from the inverse forming portion towards the surface facing the gas diffusion layer.

A sectional area of the coolant path formed by the inverse forming portion may be formed to be equal to or smaller than a sectional area of an adjacent coolant path.

Inverse forming portions may be spaced apart from each other in a longitudinal direction of the separators.

The inverse forming portions may be spaced apart from each other at regular intervals in the longitudinal direction of the separators.

The inverse forming portions may be spaced apart from each other at different intervals in the longitudinal direction of the separators.

Each of the separators may include a reaction portion that is provided in an intermediate region in the longitudinal direction thereof such that the membrane electrode body and the gas diffusion layer are disposed, with a first manifold hole and a second manifold hole being formed on both sides in the longitudinal direction of the separator to allow the reaction gas or the coolant to be introduced and discharged, and the inverse forming portion may be formed on at least one of outermost regions on both sides in a transverse direction of the reaction portion.

At least one of the outermost regions on both sides in the transverse direction of the reaction portion formed on the separator may alternately have a region in which the inverse forming portion is formed and a region in which the inverse forming portion is not formed, and a region adjacent to the first manifold hole and the second manifold hole may be formed as the region where the inverse forming portion is not formed.

The pair of separators may be a path type separator that is bent so that a land and a channel are formed.

One of the pair of separators may be a path type separator that is bent so that a land and a channel are formed, and a remaining separator may be a porous separator including a flat plate in which a region facing the reaction portion is formed flat, and a porous body which is disposed between the flat plate and the gas diffusion layer to allow the reaction gas to flow therethrough.

The inverse forming portion may be formed on the flat plate of the porous separator.

A frame supporting an edge may be provided on the membrane electrode body to form a membrane electrode assembly.

An embodiment of the present invention provides a fuel cell stack made by stacking a plurality of unit cells, wherein each of the unit cells may include a membrane electrode body, a pair of gas diffusion layers disposed on both sides of the membrane electrode body, and a pair of separators disposed outside the gas diffusion layers, and including a gas path formed on a surface facing each of the gas diffusion layers to allow reaction gas to flow therethrough, and a coolant path formed on a surface opposite to the surface facing each of the gas diffusion layers to allow coolant to flow therethrough, wherein an inverse forming portion may be formed on at least one of both sides of an outermost region in a transverse direction of each of the separators to be bent towards the surface opposite to the surface facing each of the gas diffusion layers.

According to an embodiment of the present invention, the performance and durability of a fuel cell stack can be improved by improving an outermost structure of a separator in a transverse direction and thereby preventing an excessive amount of coolant from flowing in a specific region.

### BRIEF DESCRIPTION OF THE DRAWINGS

The above and other objectives, features, and other advantages of embodiments of the present invention will be more clearly understood from the following detailed description when taken in conjunction with the accompanying drawings, in which:

FIG. 1 is a plan view illustrating a separator applied to a unit cell for a general fuel cell;

FIG. 2 is a sectional view illustrating a unit cell to which a general path type separator is applied;

FIG. 3 is a sectional view illustrating a unit cell to which a general porous separator is applied;

FIG. 4 is a plan view illustrating a separator applied to a unit cell for a fuel cell in accordance with an embodiment of the present invention;

FIG. 5 is a sectional view illustrating a unit cell to which a path type separator in accordance with an embodiment of the present invention is applied;

FIG. 6 is a sectional view illustrating a unit cell to which a porous separator in accordance with another embodiment of the present invention is applied; and

FIG. 7 is a sectional view taken along line C-C′ of FIG. 4.

### DETAILED DESCRIPTION OF ILLUSTRATIVE EMBODIMENTS

Hereinafter, exemplary embodiments of the present invention will be described in detail with reference to the accompanying drawings. However, the present invention may be implemented in various forms without being limited to embodiments that will be described below. These embodiments are intended to make the present invention complete, and are provided to completely convey the scope of the present invention to those skilled in the aft. Like reference numerals denote like elements throughout the drawings.

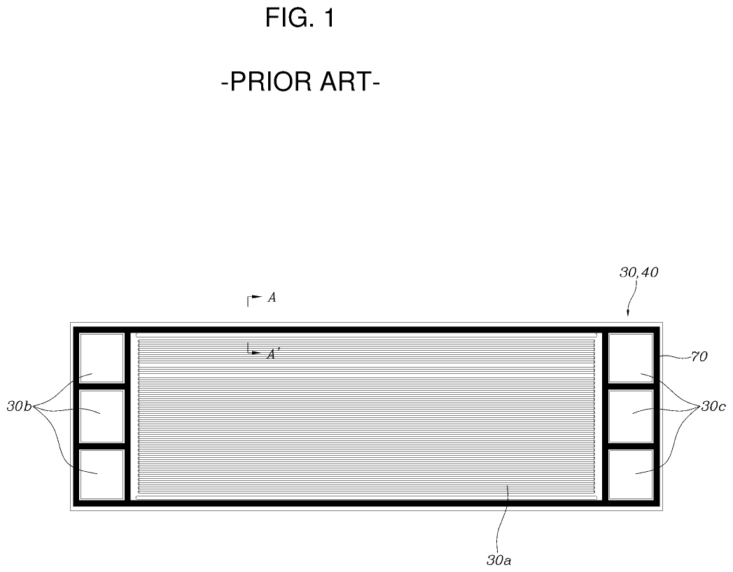

FIG. 1 is a plan view illustrating a separator applied to a unit cell for a general fuel cell.

As shown in FIG. 1, each separator 30 or 40 includes a reaction portion 30a that is provided in an intermediate region in a longitudinal direction thereof such that a MEA 11 and a gas diffusion layer 20 are disposed, and a first manifold hole 30b and a second manifold hole 30c are formed on both sides in the longitudinal direction of each separator 30 or 40 to allow the reaction gas or the coolant to be introduced and discharged.

Thus, the reaction gas and the coolant introduced into one of the first manifold hole 30b and the second manifold hole 30c flow in the reaction portion 30a, and are discharged to the remaining one of the first manifold hole 30b and the second manifold hole 30c. The manifold holes through which the reaction gas and the coolant are introduced and discharged may be changed in various ways.

Here, an airtight line 70 made of a sealing material such as a gasket is formed in each separator 30 or 40 to allow the reaction gas and the coolant to flow through a desired path and prevent the reaction gas and the coolant from leaking to an undesired region.

Meanwhile, the separators 30 and 40 are divided into an anode separator 30 that causes the flow of hydrogen, and a cathode separator 40 that causes the flow of air. Thus, the anode separator 30 is disposed as a surface facing a surface on which the anode electrode layer of the MEA 11 is formed, and the cathode separator 40 is disposed as a surface facing a surface on which the cathode electrode layer of the MEA 11 is formed.

Moreover, as anode separators 30 and cathode separators 40 of adjacent unit cells are bonded or stacked, a coolant path 60 is formed so that the coolant flows in a space therebetween.

Meanwhile, the separator may be classified into path type separators 30 and 40 and a porous separator 50, depending on a method of causing the reaction gas to flow.

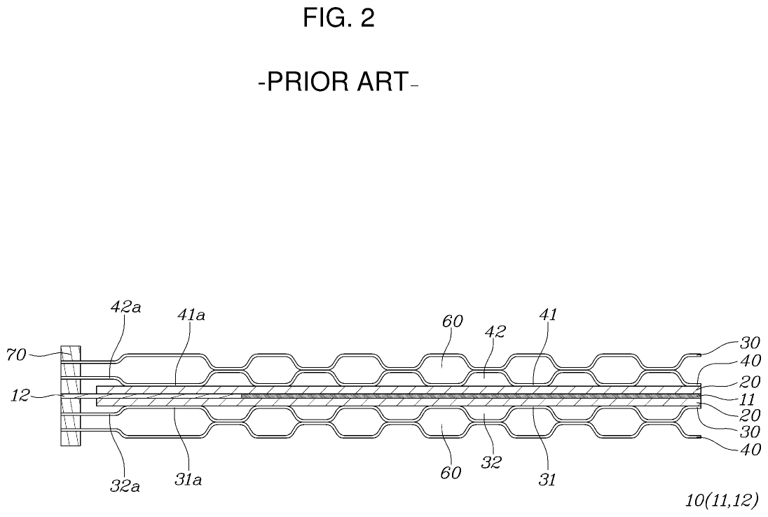

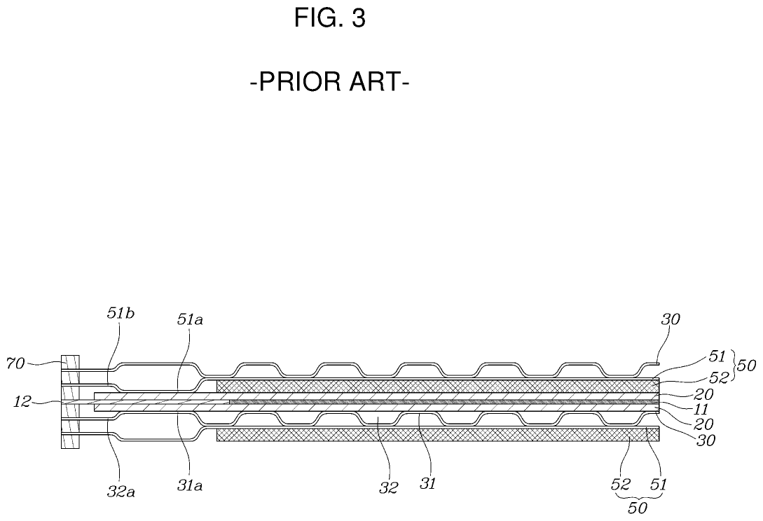

FIG. 2 is a sectional view illustrating a unit cell to which a general path type separator is applied, and FIG. 3 is a sectional view illustrating a unit cell to which a general porous separator is applied. FIGS. 2 and 3 each show a section taken along line A-A′ of FIG. 1.

As shown in FIG. 2, in the case of the unit cell to which the general path type separators 30 and 40 are applied, both the anode separator 30 and the cathode separator 40 employ the path type separator.

The path type separator 30 or 40 is bent to form a land 31 or 41 and a channel 32 or 42, so that the land 31 or 41 is supported by a gas diffusion layer 20 and the reaction gas flows through the channel 32 or 42. Moreover, while adjacent separators 30 and 40 are bonded or stacked, the coolant path 60 is formed so that the coolant flows in a space between the lands 31 and 41 formed on the respective separators 30 and 40.

Moreover, as shown in FIG. 3, in the unit cell to which the general porous separator is applied, the path type separator is applied to the anode separator 30, and the porous separator 50 is applied to the cathode separator 40. Of course, in the unit cell to which the porous separator 50 is applied, the porous separator 50 may be applied to the anode separator 30, and the path type separator may be applied to the cathode separator 40.

In this case, the porous separator 50 is composed of a flat plate 51 that is formed flat, and a porous body 52 that is disposed between the flat plate 51 and the gas diffusion layer 20 to cause the reaction gas to flow therethrough.

The porous body 52 is formed as follows: an uneven portion having a predetermined height is formed in a zigzag shape by forming a hole in a thin metal plate or scratching the metal plate and then forming a desired shape therein.

Meanwhile, if the gas diffusion layer 20 is superposed on the airtight line, the general unit cell has a problem in air-tightness.

Thus, according to the related art, in order to bond the gas diffusion layer 20 and the MEA 11, the gas diffusion layer 20 is generally manufactured to be larger than the width of the MEA 11 by about 1 to 3 mm.

In consideration of the manufacturing and bonding tolerances of the MEA 11 and the gas diffusion layer 20 and gasket injection and alignment tolerances, the airtight line 70 and an outermost path formed by the separators 30 and 40 are formed distant from each other. However, if such a configuration is maintained, a path in which the reaction gas flows is formed larger than other regions, so that an excessive amount of reaction gas flows to the associated path, thereby causing an unbalanced flow rate of the reaction gas.

Thus, as shown in FIG. 2, forming portions 31a and 41a should be inevitably formed, which increase the width of the lands 31 and 41 formed in the outermost region adjacent to flat portions 32a and 42a to which the airtight line 70 is attached.

However, the forming portions 31a and 41a may relatively increase the sectional area of the coolant path 60 in which the coolant flows, thus causing the excessive flow rate of the coolant.

The flow imbalance of the coolant lowers the heat transfer rate of the unit cell, which in turn adversely affects the performance and durability of the fuel cell stack.

This problem becomes more serious in the porous separator.

As shown in FIG. 3, the flat plate 51 of the porous separator 50 include a flat portion 51b formed in the outermost region so that the airtight line 70 is attached, and a forming portion 51a bent between the flat portion 51b and a region where the porous body 52 is disposed, in a similar manner to the lands 31 and 41 of the path type separators 30 and 40. In this case, the sectional area of the coolant path 60 in which the coolant flows is relatively increased by the forming portion 51a, thus causing the excessive flow rate of the coolant.

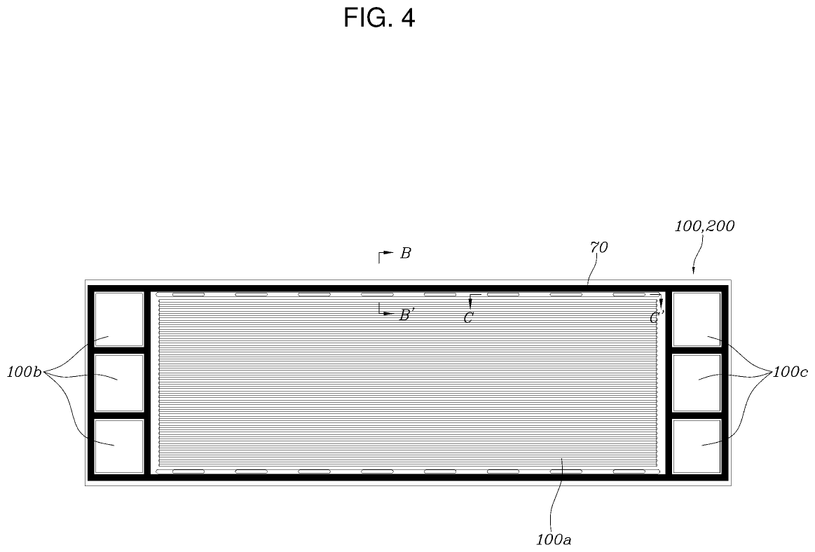

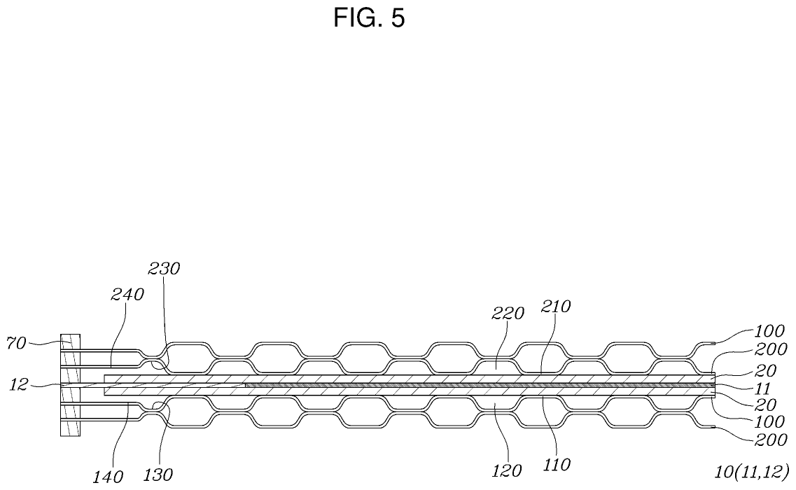

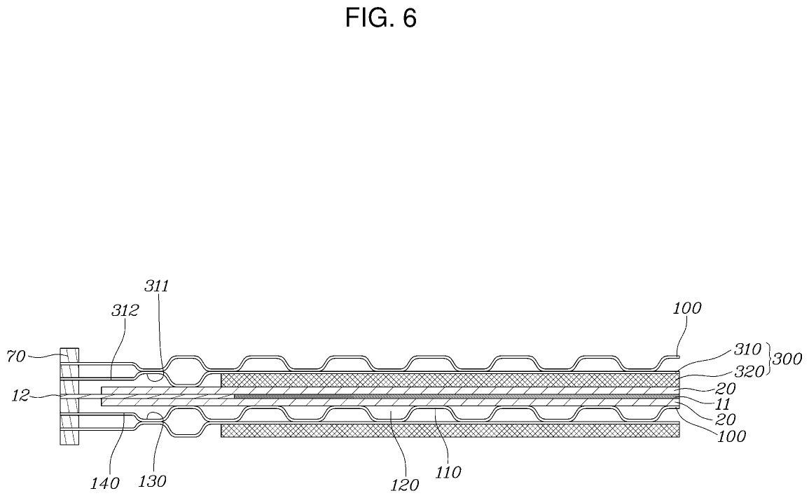

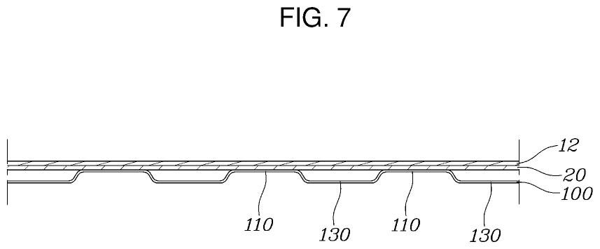

FIG. 4 is a plan view illustrating a separator applied to a unit cell for a fuel cell in accordance with an embodiment of the present invention, FIG. 5 is a sectional view illustrating a unit cell to which a path type separator in accordance with an embodiment of the present invention is applied, FIG. 6 is a sectional view illustrating a unit cell to which a porous separator in accordance with another embodiment of the present invention is applied, and FIG. 7 is a sectional view taken along line C-C′ of FIG. 4. FIGS. 5 and 6 each show a section taken along line B-B′ of FIG. 4.

The separator that is applied to the unit cell for the fuel cell in accordance with the embodiment of the present invention may be applied to both a path type separator and a porous separator.

For example, in the case of applying the path type separator, both an anode separator 100 and a cathode separator 200 may employ the path type separator, as shown in FIG. 5.

Moreover, in the case of applying the porous separator, the anode separator 100 may employ the path type separator, and the cathode separator 200 may employ the porous separator 300, as shown in FIG. 6.

In this regard, the basic configuration of the path type separators 100 and 200 is similar to the configuration of the general path type separator having a land and a channel, while the basic configuration of the porous separator 300 is similar to the general porous separator composed of a flat plate and a porous body. Thus, the detailed description of the basic configuration of the path type separator and the porous separator will be omitted herein.

Each of the separators 100, 200 and 300 according to embodiments of the present invention is improved in shape to reduce the sectional area of a coolant path on at least one of both sides of an outermost region in a transverse direction. Hereinafter, improved parts in the separators 100, 200 and 300 will be described in detail.

First, the unit cell to which the path type separator is applied will be described.

As shown in FIGS. 4 and 5, the unit cell for the fuel cell in accordance with the embodiment of the present invention includes a membrane electrode assembly 10 that is composed of a membrane electrode body 11 and a frame 12 supporting the edge of the membrane electrode body 11, a pair of gas diffusion layers 20 that are disposed on both sides of the membrane electrode assembly 10, and a pair of separators 100 and 200 that are disposed outside the gas diffusion layers 20, have on a surface facing each gas diffusion layer 20 a gas path in which reaction gas flows, and have on a surface opposite to the surface facing the gas diffusion layer 20 a coolant path 60 in which coolant flows.

Here, the separators are divided into an anode separator 100 and a cathode separator 200. Both the anode separator 100 and the cathode separator 200 are the path type separator.

Each of the separators 100 and 200 includes a reaction portion bow that is provided in an intermediate region in a longitudinal direction thereof such that the membrane electrode body 11 and the gas diffusion layer 20 are disposed, and a first manifold hole mob and a second manifold hole 100c formed on both sides in the longitudinal direction of each separator 100 or 200 to allow the reaction gas or the coolant to be introduced and discharged.

Thus, the reaction gas and the coolant introduced into one of the first manifold hole mob and the second manifold hole 100c flow in the reaction portion bow, and are discharged to the remaining one of the first manifold hole 100b and the second manifold hole 100c. The manifold holes through which the reaction gas and the coolant are introduced and discharged may be changed in various ways.

Moreover, an airtight line 70 made of a sealing material such as a gasket is formed in each of the separators 100 and 200 to allow the reaction gas and the coolant to flow through a desired path and prevent the reaction gas and the coolant from leaking to an undesired region.

Meanwhile, lands 110 and 210 and channels 120 and 220 are formed in the separators 100 and 200. In order to reduce the sectional area of the coolant path 60, inverse forming portions 130 and 230 are formed on both sides of the outermost region in the transverse direction of each separator 100 or 200 to be bent in a direction opposite to the surface facing the gas diffusion layer 20.

Preferably, the inverse forming portions 130 and 230 are formed on the outermost regions of both sides in the transverse direction of the reaction portion bow of each of the separators 100 and 200. Of course, the inverse forming portions 130 and 230 may be formed on only one of the outermost regions of both sides in the transverse direction of the reaction portion bow of each of the separators 100 and 200.

Meanwhile, the inverse forming portions 130 and 230 are bent in a shape similar to that of the channels 120 and 220 formed on the separators 100 and 200.

Moreover, flat portions 140 and 240 are formed on the separators 100 and 200 to extend flat in the outward direction of the separators 100 and 200 while being bent from the inverse forming portions 130 and 230 towards the surface facing each gas diffusion layer 20. Thus, the airtight line 70 is formed on the flat portions 140 and 240.

Preferably, the flat portions 140 and 240 are bent in the same direction as the lands 110 and 210 formed on the separators 100 and 200, but are bent such that they are not in contact with the gas diffusion layers 20.

Moreover, the anode separators 100 and the cathode separators 200 of the unit cells which are adjacent to each other are in close contact with each other while being bonded or stacked. Thus, the inverse forming portion 130 and the flat portion 140 formed on the anode separator 100 are in close contact with the inverse forming portion 230 and the flat portion 240 formed on the cathode separator 200, so that the sectional area in which the coolant path 60 is formed is reduced by an area corresponding to a contact region between the inverse forming portions 130 and 230 in the outermost regions of the separators 100 and 200.

Thus, as compared to the conventional separator, the sectional area of the coolant path in the outermost region of each of the separators 100 and 200 is reduced, thus preventing an excessive amount of coolant from flowing to an associated region.

Moreover, the inverse forming portion 130 formed on the anode separator 100 and the inverse forming portion 230 formed on the cathode separator 200 come into close contact with each other, so that a contact region between the inverse forming portions 130 and 230 may be formed at the outermost regions of the separators 100 and 200, and thereby a more stable structure may be provided when unit cells are stacked.

Meanwhile, in order to keep the flow volume of the coolant for each region uniform, the sectional area of the coolant path 60 formed by the inverse forming portions 130 and 230 is preferably formed to be equal to or smaller than the sectional area of the adjacent coolant path 60.

As shown in FIGS. 4 to 7, the inverse forming portions 130 and 230 are preferably spaced apart from each other in the longitudinal direction of the separators 100 and 200. Here, the inverse forming portions 130 and 230 are preferably spaced apart from each other at the same interval. However, without being limited thereto, an interval between the inverse forming portions may be varied or be increased or reduced at a constant rate.

Thus, the outermost regions on both sides in the transverse direction of the reaction portion bow formed on the separators 100 and 200 alternately have a region in which the inverse forming portions 130 and 230 are formed and a region in which the inverse forming portions 130 and 230 are not formed. Preferably, the region adjacent to the first manifold hole 100b and the second manifold hole 100c is formed as the region where the inverse forming portions 130 and 230 are not formed.

The reason is as follows: in the case of forming the inverse forming portions 130 and 230 in the region adjacent to the first manifold hole 100b and the second manifold hole 100c where the reaction gas or the coolant is introduced, the sectional area of the path where the reaction gas or the coolant flows is relatively increased and the flow rate of the reaction gas or the coolant is increased. Thus, the flow rate of the reaction gas or the coolant becomes non-uniform and the performance of the fuel cell stack is deteriorated.

Furthermore, in the case of forming the inverse forming portions 130 and 230 in the region adjacent to the first manifold hole 100b and the region adjacent to the second manifold hole 100c, there may occur a problem where an empty space is formed by the inverse forming portions 130 and 230 and thereby the structural stability is deteriorated in an associated region when the fuel cell stack is formed by stacking multiple unit cells.

Next, the unit cell to which the porous separator is applied will be described.

As shown in FIG. 6, in the unit cell to which the porous separator is applied, the path type separator is applied to the anode separator 100, and the porous separator 300 is applied to the cathode separator 200.

Thus, the anode separator 100 employs the path type separator of the above-described embodiment.

Moreover, the porous separator 300 includes a flat plate 310 in which a region facing the reaction portion bow is formed flat, and a porous body 320 which is disposed between the flat plate 310 and the gas diffusion layer 20 to allow the reaction gas to flow therethrough.

Thus, similarly to the above-described configuration, an inverse forming portion 311 and a flat portion 312 are formed in the flat plate 310.

In this regard, the inverse forming portion 311 and the flat portion 312 formed in the flat plate 310 are formed to be symmetrical with the inverse forming portion 130 and the flat portion 140 formed in the anode separator 100. Thus, while the anode separators 100 and the porous separators 300 of the unit cells which are adjacent to each other are bonded and stacked, the inverse forming portion 130 and the flat portion 140 formed in the anode separator 100 come into close contact with the inverse forming portion 311 and the flat portion 312 formed in the flat plate 310 of the porous separator 300, so that the sectional area in which the coolant path 60 is formed is reduced by an area corresponding to the contact region between the inverse forming portion 130 formed in the anode separator 100 and the inverse forming portion 311 formed in the flat plate 310 of the porous separator 300 in the outermost region of the separator.

Therefore, the sectional area of the coolant path is reduced in the outermost region of each of the separators 100 and 300, as compared with the conventional separator, thus preventing an excessive amount of coolant from flowing in an associated region.

Meanwhile, the fuel cell stack in accordance with the embodiment of the present invention is formed by preparing and stacking multiple unit cells.

In this case, the anode separators 100 and the cathode separators 200 of adjacent unit cells come into close contact with each other while being bonded or stacked. Thus, the coolant path in which the coolant flows is formed between the anode separator 100 and the cathode separator 200.

Although the present invention was described with reference to specific embodiments shown in the drawings, it is apparent to those skilled in the art that the present invention may be changed and modified in various ways without departing from the scope of the present invention, which is described in the following claims.

What is claimed is:

1. A unit cell for a fuel cell, the unit cell comprising:
a membrane electrode body;
a pair of gas diffusion layers disposed on both sides of the membrane electrode body; and
a pair of separators disposed outside the gas diffusion layers, and including a gas path formed on a surface facing each of the gas diffusion layers and configured to allow reaction gas to flow therethrough, and a coolant path formed on a surface opposite to the surface facing each of the gas diffusion layers and configured to allow coolant to flow therethrough,
wherein an inverse forming portion is formed on at least one of both sides of an outermost region in a transverse direction of each of the separators to be bent towards the surface opposite to the surface facing each of the gas diffusion layers.

2. The unit cell of claim 1, wherein each of the separators comprises a flat portion to extend in an outward direction of the separator while being bent from the inverse forming portion towards the surface facing the gas diffusion layer.

3. The unit cell of claim 1, wherein a sectional area of the coolant path formed by the inverse forming portion is equal to or smaller than a sectional area of an adjacent coolant path.

4. The unit cell of claim 1, further comprising inverse forming portions spaced apart from each other in a longitudinal direction of the pair of separators.

5. The unit cell of claim 4, wherein the inverse forming portions are spaced apart from each other at regular intervals in the longitudinal direction of the pair of separators.

6. The unit cell of claim 4, wherein the inverse forming portions are spaced apart from each other at different intervals in the longitudinal direction of the pair of separators.

7. The unit cell of claim 4, wherein:
each of the separators comprises a reaction portion provided in an intermediate region in the longitudinal direction of the separator such that the membrane electrode body and the gas diffusion layer are disposed, with a first manifold hole and a second manifold hole being formed on both sides in the longitudinal direction of the separator to allow the reaction gas or the coolant to be introduced and discharged; and
the inverse forming portions are formed on at least one of outermost regions on both sides in a transverse direction of the reaction portion.

8. The unit cell of claim 7, wherein:
at least one of the outermost regions on both sides in the transverse direction of the reaction portion formed on the separator alternately has a region in which the inverse forming portion is formed and a region in which the inverse forming portion is not formed; and
a region adjacent to the first manifold hole and the second manifold hole is formed as the region in which the inverse forming portion is not formed.

9. The unit cell of claim 1, wherein the pair of separators is a path type separator that is bent so that a land and a channel are formed.

10. The unit cell of claim 1, wherein:
one of the pair of separators is a path type separator that is bent so that a land and a channel are formed; and
a remaining one of the pair of separators is a porous separator comprising:
a flat plate in which a region facing a reaction portion is formed flat; and
a porous body disposed between the flat plate and the gas diffusion layer to allow the reaction gas to flow therethrough.

11. The unit cell of claim 10, wherein the inverse forming portion is formed on the flat plate of the porous separator.

12. The unit cell of claim 1, wherein a frame supporting an edge is provided on the membrane electrode body to form a membrane electrode assembly.

13. A fuel cell stack comprising:
a stacked plurality of unit cells, wherein each of the unit cells comprises:
a membrane electrode body;
a pair of gas diffusion layers disposed on both sides of the membrane electrode body; and
a pair of separators disposed outside the gas diffusion layers, and including a gas path formed on a surface facing each of the gas diffusion layers and configured to allow reaction gas to flow therethrough, and a coolant path formed on a surface opposite to the surface facing each of the gas diffusion layers and configured to allow coolant to flow therethrough,
wherein an inverse forming portion is formed on at least one of both sides of an outermost region in a transverse direction of each of the separators to be bent towards the surface opposite to the surface facing each of the gas diffusion layers.

14. The fuel cell stack of claim 13, wherein each of the separators comprises a flat portion to extend in an outward direction of the separator while being bent from the inverse forming portion towards the surface facing the gas diffusion layer.

15. The fuel cell stack of claim 13, wherein a sectional area of the coolant path formed by the inverse forming portion is equal to or smaller than a sectional area of an adjacent coolant path.

16. The fuel cell stack of claim 13, further comprising inverse forming portions spaced apart from each other in a longitudinal direction of the pair of separators.

17. The fuel cell stack of claim 16, wherein the inverse forming portions are spaced apart from each other at regular intervals in the longitudinal direction of the pair of separators.

18. The fuel cell stack of claim 16, wherein the inverse forming portions are spaced apart from each other at different intervals in the longitudinal direction of the pair of separators.

19. The fuel cell stack of claim 16, wherein:
each of the separators comprises a reaction portion provided in an intermediate region in the longitudinal direction of the separator such that the membrane electrode body and the gas diffusion layer are disposed, with a first manifold hole and a second manifold hole being formed on both sides in the longitudinal direction of the separator to allow the reaction gas or the coolant to be introduced and discharged;
the inverse forming portions are formed on at least one of outermost regions on both sides in a transverse direction of the reaction portion;
at least one of the outermost regions on both sides in the transverse direction of the reaction portion formed on the separator alternately has a region in which the inverse forming portion is formed and a region in which the inverse forming portion is not formed; and
a region adjacent to the first manifold hole and the second manifold hole is formed as the region in which the inverse forming portion is not formed.

20. The fuel cell stack of claim 13, wherein:
one of the pair of separators is a path type separator that is bent so that a land and a channel are formed; and
a remaining one of the pair of separators is a porous separator comprising:
a flat plate in which a region facing a reaction portion is formed flat; and
a porous body disposed between the flat plate and the gas diffusion layer to allow the reaction gas to flow therethrough.
